(19) United States
(12) Patent Application Publication
(10) Pub. No.: US 2003/0051572 A1
(43) Pub. Date: Mar. 20, 2003

(54) 6 AL 4V titanium bicycle crank set with oversized spindle

(76) Inventor: Jason A. Sramek, Midlothian, IL (US)

Correspondence Address: Jason A. Sramek, 14575 Waverly Ave., Midlothian, IL, 60445, US

(21) Appl. No.: 09/956,353

(22) Filed: Sep. 20, 2001

(51) Int. Cl. B62M 3/00

(52) U.S. Cl. 74/594.1

(57) ABSTRACT

A titanium pedal crank and bottom bracket spindle mounting arrangement in which the bottom bracket spindle has an oversized diameter and an oversized tapered end to minimize the flex naturally associated with titanium spindles and to speed up the manufacturing process; the cranks are designed with an oversized square through pocket in communication with the spindle and an I-beam design; the mounting star is pressed fitted and TIG welded to the right-hand crank. The larger radiuses on both the spindle and in the square tapered crank hole speed up the machining process and reduce the cost of manufacture.

### BACKGROUND OF THE INVENTION

In the design and manufacture of bicycle components, strength and weight are important considerations. Ideally, a component is as light as it can be while maintaining the necessary strength to withstand the forces placed upon it.

One of the main components of a bicycle is the crank set and bottom bracket assembly. The crank set consists of two arms, which are connected to each other and through the bicycle frame by a spindle or shaft commonly referred as the “bottom bracket”. A mounting star is affixed to the right-sided crank arm to provide a securing device to the front chain sprocket. Pedals are then attached to the opposite ends of the arms allowing a rider to exert force on the pedals which turns the front sprocket mechanism.

Traditionally, most spindles are made of hardened steel ⅝ inch in diameter with a tapered square (or splined) ends to affix the arms. Because considerable vertical forces are exerted on the tapered square endings, hardened steel is the most commonly used material. Titanium is a preferable material because it is stronger than hardened steel and is only one-third of the weight. However, titanium has a certain degree of natural “flex” which is not found in hardened steel and for that reason, titanium is not commonly used in the manufacturing of bottom bracket spindles. The characteristic “flex” of titanium can cause excessive bearing wear resulting in failure of the mechanism. Therefore, the problem presented is to utilize a design and manufacturing process in which titanium material is used but “flexing” is minimized. The following described process accomplishes that goal.

### BRIEF SUMMARY OF THE INVENTION

When designing bicycle components, weight is of primary concern to expert cyclists. 6Al-4V titanium has one of the highest strength to weight ratios of all metals. 6Al-4V titanium also has measurable natural flex due to its high modulus of elasticity. This natural flex makes it a poor material of choice for bottom bracket spindles, particularly in the case of riders above 160 Pounds, and can lead to shaft failure or premature bearing wear. The spindle submitted by the applicant has a larger diameter than spindles commonly manufactured in the industry, both Titanium and hardened steel. The 3 degree squared tapered interface to the crank arm is also larger than the industry standard. Because of the larger design, the parts of this assembly are not interchangeable with the current designs the bicycle industry; however, the enlargement of the spindle diameter and crank taper significantly reduce the flex commonly associated with standard 6Al-4V Titanium Bottom bracket spindle designs. Enlarging the size of this square tapered interface also makes it easier and faster to machine on a Vertical machining center.

The mounting star is machined separately from the crank arm and attached by press fitting to the crank arm. Because of the high cost of titanium, it is more cost effective to machine the mounting star separately. The mounting star is then TIG welded to right-sided crank arm.

The crank arms maintain a true I-beam design to minimize weight without compromising strength. The I-beam design facilitates the machining process as well.

### BRIEF DESCRIPTION OF THE SEVERAL VIEWS OF THE DRAWING

FIG. 1 depicts an isometric exploded view of the right-sided crank arm, mounting star and spindle. A squared boss with rounded corners is machined to the crank arm on its interior aspect on which the star is pressed and then TIG welded. This crank arm will work for both the right and left side with the only difference being one will have a standard right hand pedal thread and the other a left-hand thread.

FIG. 1B is an isometric view of the star, which presses onto the crank arm and is then welded on both the top and bottom.

FIG. 1C is an isometric view of the oversized 6Al-4V Titanium bottom bracket spindle with one ½ inch*20 unf tapped hole on each end. The bottom bracket tapered square end is pressed into the crank arm with a Titanium bolt.

FIGS. 2A-2C are two isometric views and one side view of the 6AL-4V Titanium crank arm. FIG. 2C shows the enlarged squared tapered hole on the right side of the part which is one of the claims.

FIG. 3A is a top view of the oversized bottom bracket spindle clearly showing it's oversized spindle which is 0.213 inches larger than the industry standard at the outermost end of the taper and a claim. This figure shows the enlargement of the size of the taper which is not standardized with the rest of the industry and is the first of it's kind. FIG. 3B illustrates a side view of the enlarged spindle. This view also shows the through hole for additional weight savings. FIG. 3C is an isometric view of the bottom bracket spindle.

FIG. 4A is a view of the innermost side of either crank arm. This view shows the square boss with rounded corners that the chainring star will be pressed and welded to.

FIG. 4B is a Top view of the crank arm which shows the oversized tapered square hole which is one of the claims of this design along with the first of it's kind non-compatible with industry standards.

FIG. 4C is an outermost view of the crank arm which illustrates the pedal hole on the left side and the oversized square spindle hole on the right.

FIG. 5A is an isometric view of the chainring star, which is press fit and welded onto the crank arm. Five tubular parts shown with internal thread holes are press fit and then welded to the star to provide a means of attachment for the standard three chainrings. Separating these tubular parts from the main star allows the star to be manufactured with less material waste.

FIGS. 5B and 5C are top and side views, respectively of the chainring star. FIG. 5C shows a 0.4*1.1395 inch pockets cut into each of the five legs of the star to lessen the weight of the star.

### DETAILED DESCRIPTION OF THE INVENTION

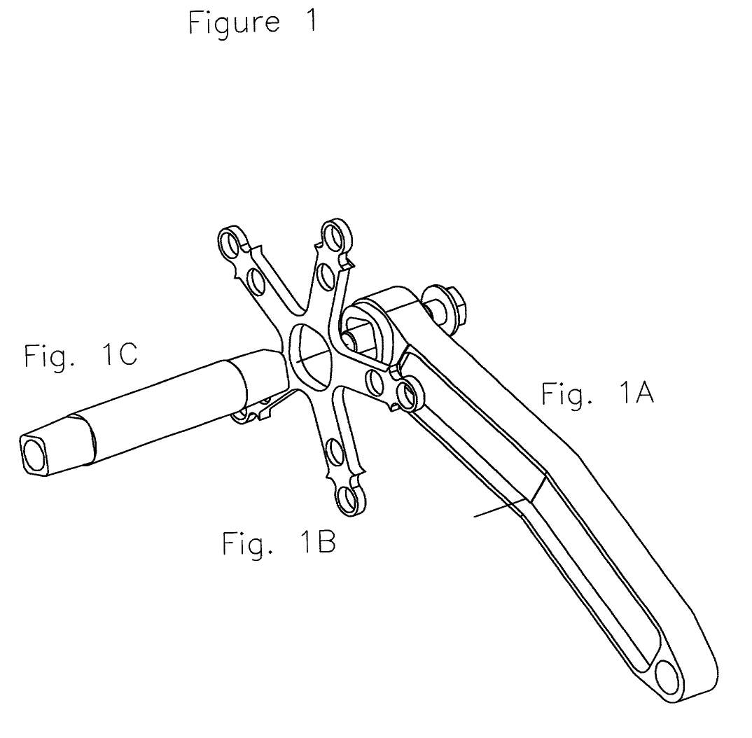

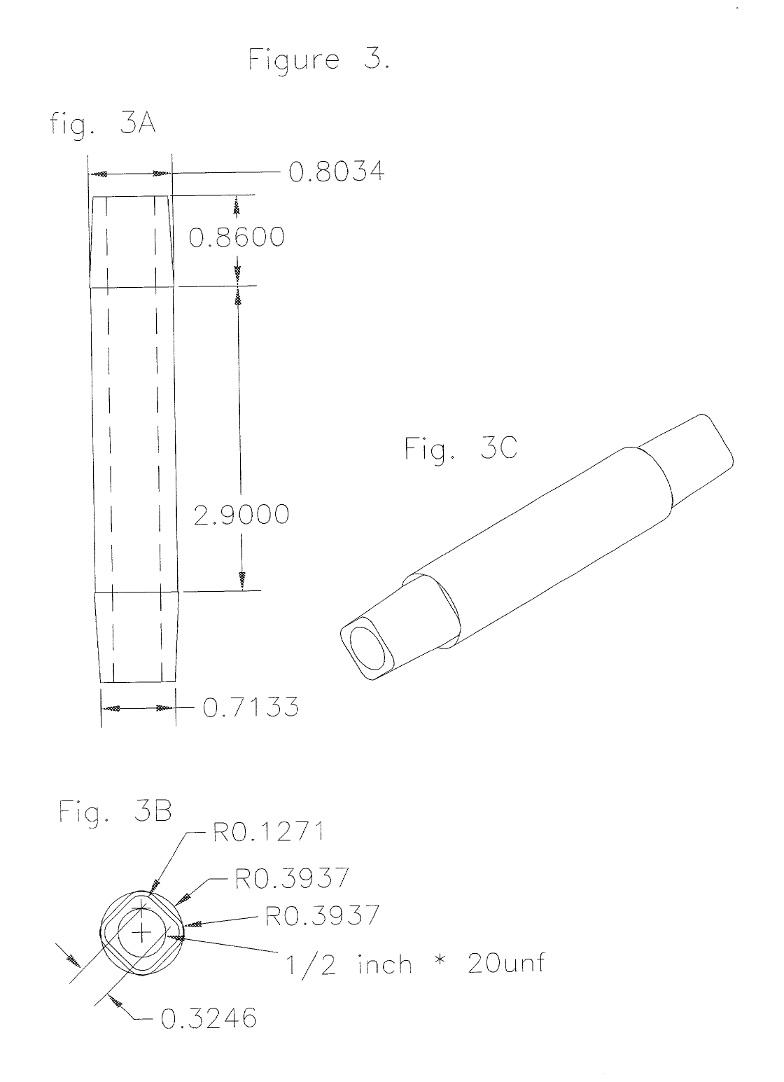

There is one major problem associated with the current standard square tapered end bottom bracket spindle design when 6Al-4V Titanium is used. This problem is flex in the spindle itself. The standard diameter for these industry standard spindles is ⅝ inch in the center part of the spindle. The outer most part of all current Titanium spindles, measures to ½ inch. By increasing the diameter of the spindle (FIGS. 1C and 3), the flex associated with these standard designs is reduced.

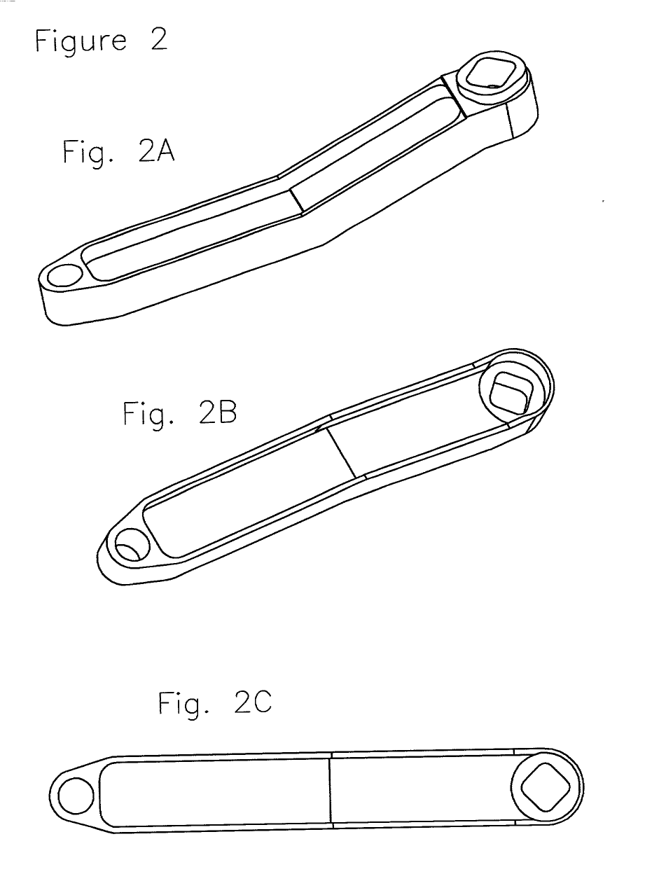

The other major benefit to making a larger square tapered end is the ease of machining its counterpart square taper hole in the crank arm (FIGS. 1A, 2, and 4). One method of machining this square tapered hole is to start by drilling a ½ inch diameter pilot hole in the crank arm. After the hole is drilled a 3 degree tapered end mill is then used to machine out the remaining material to make the hole square with ⅛-radius corners. In the old design the radiuses of the square tapered hole are ⅛-inch diameter at the outermost end. This requires the use of a ⅛ inch diameter endmill cutter. This end mill cutter is very small and therefore the part must be machined at a very slow rate.

This is so the ⅛ inch end mill cutter does not chatter and break. Most of the crank arms currently are made of Aluminum. Aluminum is very easy to machine or cast so this removal of the remaining material in the square tapered hole at slow speeds is possible. 6Al-4V Titanium, however, is very difficult to machine. The use of a ⅛ inch endmill cutter would result in frequent tapered end mill cutter breakage. In my design, I have increased the radiuses to a 3-degree taper ¼ inch tip diameter end mill cutter. This allows the use of a 3 degree tapered endmill cutter with a ¼ inch diameter tip. Machining the remainder of the square tapered hole diameter in Titanium will therefore be faster and more reliable reducing the cost of production of a Solid 6AL-4V Titanium crank arm. By manufacturing the right side crank arm and star from separate Titanium plates (see FIG. 1) and welding the two together after machining, the amount of waste material is reduced which is very important when manufacturing with an expensive metal like 6Al-4V Titanium.

The spindle (see FIGS. 1C and 3), will first be turned from solid 6AL-4V Titanium on a CNC turning center. The finish diameters will be machined followed by the through hole and hole tapping on both sides (see FIG. 3B). From their the spindles will be placed in a vertical machining center where the Square tapered surfaces will be machined with a large diameter tapered 3 degree tapered end mill in two separate operations.

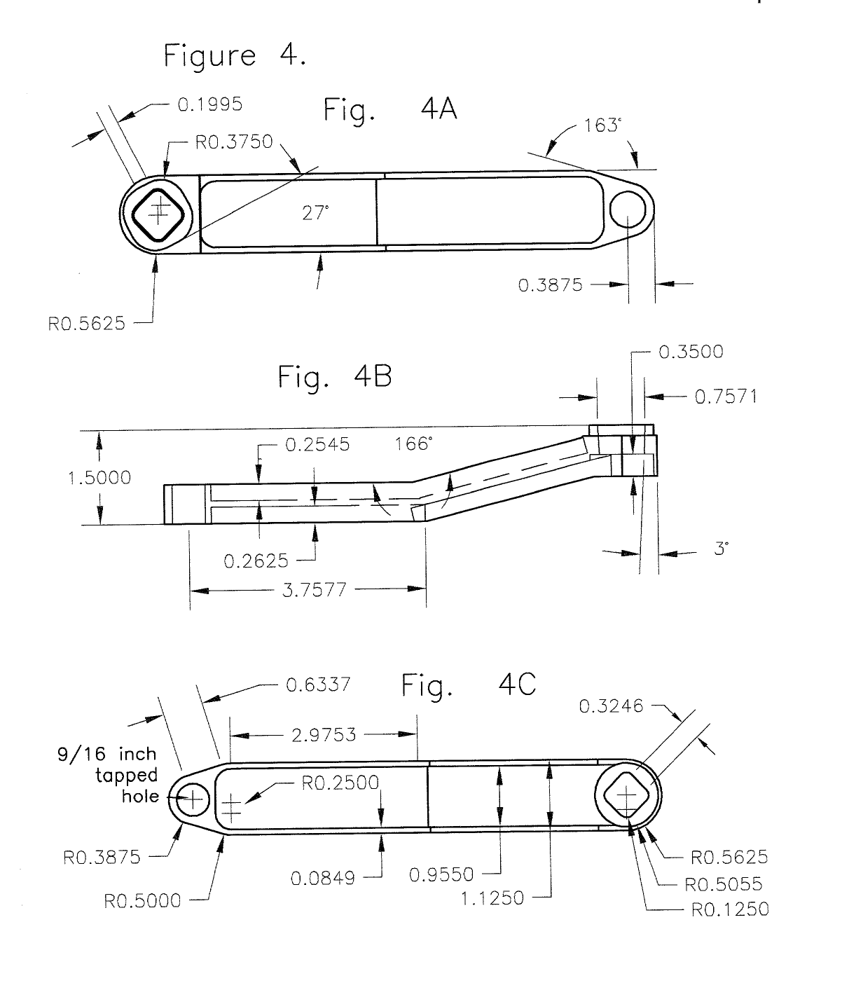

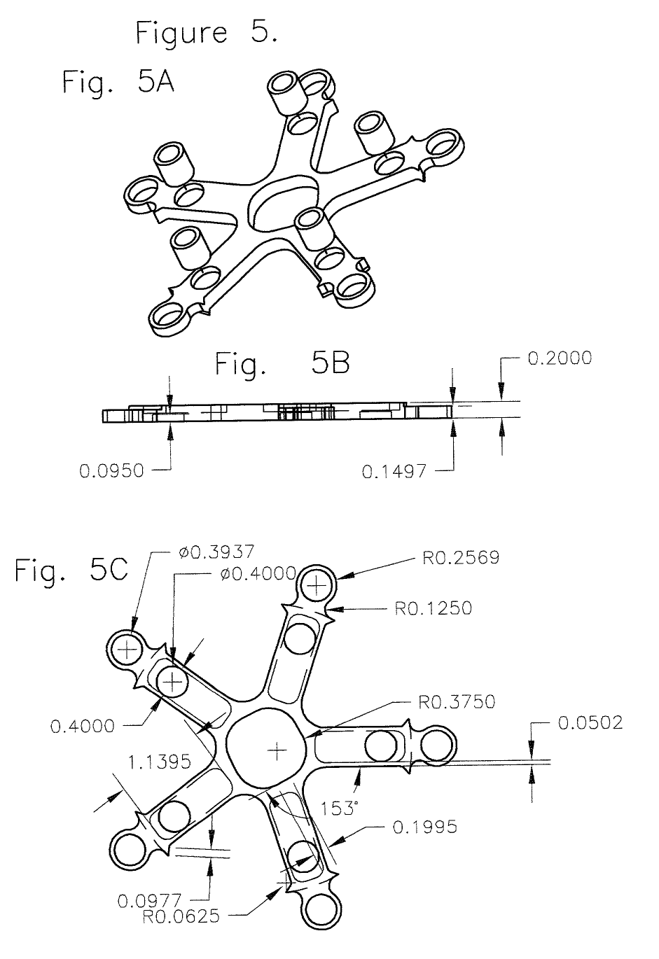

The Titanium arms (see FIG. 4) will first be bandsawed from 1.25 6Al -4V Titanium plate to rough size. The top surfaces shown in FIG. 4B will then be faced in two separate face milling operations. Two additional operations will then be required to machine both the inner and outer sides of the crank arm shown in FIGS. 4A and C. The enlarged tapered square holes, tapped pedals holes and weight reduction pockets will also be machined in the two fore mentioned machining operations.

What I claim as my invention is:

1. A titanium crank spindle unit for bicycles comprising:
Titanium crank spindle having a larger diameter (0.7874 inches) than present industry standards;
Titanium crank spindle having a larger tapered end than present industry standards;
a titanium crank spindle, that because of its design, will have minimum flex and maximum strength;
a titanium crank arm, that because of its I-beam design, will have minimum weight and maximum strength;
